(19) United States
(12) Patent Application Publication
(10) Pub. No.: US 2007/0051764 A1
(43) Pub. Date: Mar. 8, 2007

(54) FOLDING FLOOR MOUNTED CONSOLE

(75) Inventors: Alan Sturt, West Bloomfield, MI (US); Larry Holmes, Oak Park, MI (US); Jeff A Kempf, Romeo, MI (US)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/904,507

(22) Filed: Aug. 26, 2005

(51) Int. Cl. B60R 7/00; B60R 9/00; B60R 11/00

(52) U.S. Cl. 224/539; 224/42.34

(57) ABSTRACT

A folding floor console providing storable beverage container holders and/or other storage devices is shown. The folding floor console comprises a base unit and at least one pivotally mounted lid unit that when open exposes for use said beverage container holders or other storage devices. Further shown is a folding floor console that when opened forms an open bin-like storage unit with flexible sidewalls.

### BACKGROUND OF THE INVENTION

1. Field of the Invention

The present invention generally relates to a vehicle accessory with folding features. More particularly to a folding floor mounted console that has item holders that pivotally open for use and close for storage in a base.

2. Description of the Related Art

Vehicle interior components are increasingly including convenience items for the vehicle operator and passengers. Center consoles located between seats is a typical accessory which may include a storage compartment having a hinged cover also forming an armrest at the top of the console. It is common for these consoles to have armrest covers which could be raised on a hinge mechanism to expose a storage compartment or other features.

For example, U.S. Pat. No. 5,372,403 issued Dec. 13, 1994 to Puerto teaches an armrest containing a retractable writing surface and a pivoting lid.

U.S. Pat. No. 5,524,958 issued Jun. 11, 1996 to Wieczorek et al. teaches an armrest with a retractable beverage container holder.

U.S. Pat. No. 6,203,088 issued Mar. 20, 2001 to Fernandez et al. teaches a console moveable along a track and having pivoting lid and retractable units.

U.S. Pat. No. 6,419,314 issued Jul. 16, 2002 to Scheerhorn teaches a console with a pivoting lid that is also slidable.

U.S. Patent Application Publication Number 2002/0089203 published Jul. 11, 2002 to Flowerday et al. teaches a console having a two part sliding lid access to a storage bin.

U.S. Patent Application Publication Number 2002/0089217 published Jul. 11, 2002 to Scheerhorn teaches a console with a pivoting lid that is also slidable.

WIPO International Publication Number WO 2004/024508 published Mar. 25, 2004 to Clark et al. teaches a console having a storage bin with mesh sides and a sliding or pivoting lid.

A difficulty with some consoles with pivoting covers or armrests is that they do not lend themselves to placement anywhere other than between bucket type seats. Additionally, the need for general storage bins has given way to the need for storage areas specifically designed for a specific function such as, for example, holding beverage containers, and storing CD's or DVD's. As a result, there exists a need for an assembly for a vehicle interior component which may be mounted in a variety of floor locations within a vehicle passenger compartment and which is designed to provide specialized safe convenient storage for items such as beverage containers, CD's, DVD's and the like, but which may be closed providing a clean unobstructed space within the vehicle during periods of non-use.

### DISCLOSURE OF THE INVENTION

The present invention provides advantages and alternatives over the prior art by providing a floor mounted console having storage features for specific types of items and that may be located in various locations within a vehicle passenger compartment.

According to a further aspect of the present invention, there is presented an economical and easily installed folding floor console having a clean obstruction free profile when in a closed non-use position.

According to yet another aspect of the present invention there is presented a console for storing items that does not require a large overall volume when not being used.

According to a yet further aspect of the present invention there is provided a folding floor console for mounting in a vehicle to hold beverage containers and personal items in an organized manner comprising: a tray base unit having pivotally mounted therein at least one lid, allowing said at least one lid to move from a closed position to an open position; and said at least one lid having an exterior surface and an interior surface wherein on said interior surface is pivotally mounted a storage device; thereby allowing for the storage of beverage containers and other personal items as desired when said at least one lid is in an open position and providing a unencumbered vehicle compartment space when said at least one lid is in a closed position.

### BRIEF DESCRIPTION OF THE DRAWINGS

FIG. 1 shows a perspective view of one embodiment of the folding floor console of the present invention in a closed or non-use position.

FIG. 2 shows a perspective view of one embodiment of the folding floor console of the present invention in an open or use position

FIG. 3 shows a partial perspective view of one embodiment of the folding floor console of the present invention showing the opening of a beverage container apparatus.

FIG. 4 shows the partial perspective view of FIG. 3 with a typical beverage bottle mounted in the open beverage container apparatus.

FIG. 5 shows a partial perspective view of one embodiment of the folding floor console of the present invention adapted to store and display CD's or DVD's.

FIG. 6 shows a perspective view of another preferred embodiment of the folding floor console of the present invention forming an open storage bin having retractable side panels.

FIG. 7 shows a perspective view of another preferred embodiment of the present invention lid comprising a lid portion and a separate beverage holder assembly moveably mounted therein.

FIG. 8 shows a partial perspective view of a preferred embodiment of the base unit of the present invention having a lid engaging assembly

FIG. 9 shows a partial cross sectional view of the lid and base unit of FIG. 8 showing the lid engaged in the lid engaging assembly when in a lid open position.

FIG. 10 shows a partial cross sectional view of the lid and base unit of FIG. 8 showing the lid engaged in the lid engaging assembly when in a lid closed position.

### DESCRIPTION OF THE PREFERRED EMBODIMENTS OF THE INVENTION

The present invention comprises a folding floor mounted console that has item holders that pivotally open for use and close for storage in a base to hold items such as, for example, a beverage container, CDs, and DVDs. However, for ease of reference, the embodiment concerning a holder for a beverage container will be primarily referred to in this specification.

Reference will now be made to the drawings, wherein to the extent possible like reference numerals are utilized to designate like components throughout the various views. Referring to FIG. 1, there is presented a perspective view of a preferred embodiment of the present invention folding floor console 10 comprising a tray base unit 1 and a pair of pivotally mounted storage lids 2 in the down or closed position.

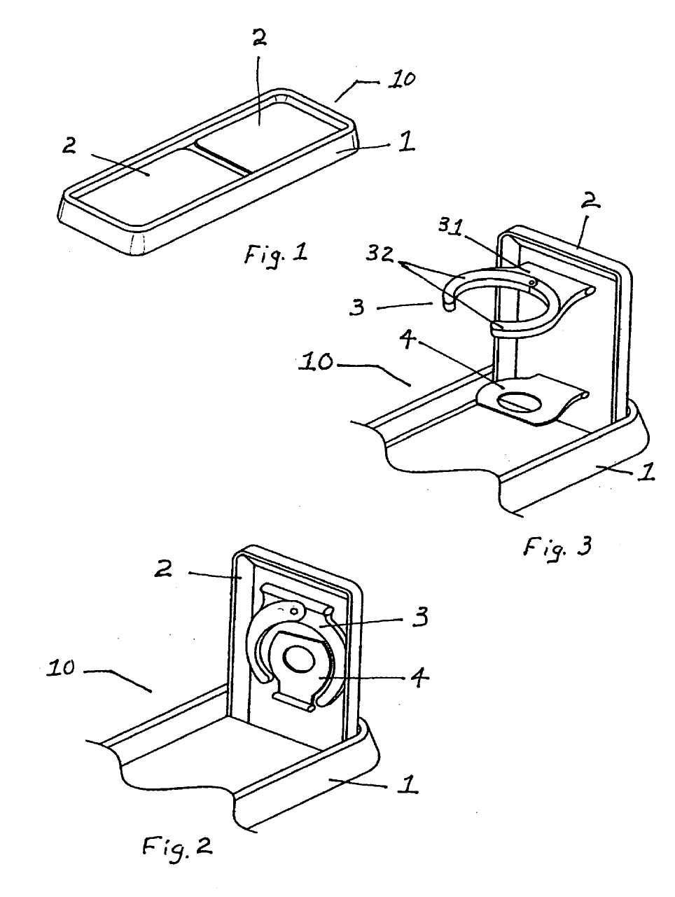

Referring now to FIG. 2, there is shown the preferred embodiment of the present invention folding floor console 10 having a tray base unit 1 and a pair of pivotally mounted lids 2 in the up or open position. As is further shown in FIG. 2 the interior of at least one of the pair of lids 2 have pivotally mounted to their interior surface a large large beverage container retainer 3 and a beverage container holder 4. The container holder 4 is used with beverage containers that are not tall enough to extend from the tray base unit 1 to the large beverage container retainer 3. The large large beverage container retainer 3 is suitable for holding beverage containers as large as one liter in size. The arrows in FIG. 2 show the movement of the pivotally mounted pair of lids during the opening of the lids for use.

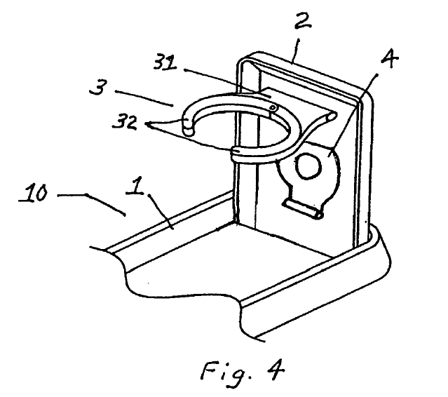

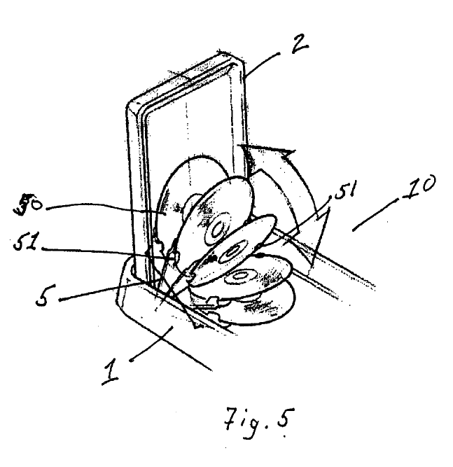

Turning now to FIG. 3, there is shown a partial perspective view of FIG. 2 showing the manner in which the container holder 4 opens for use as well as showing how the large beverage container retainer 3 opens for use. In addition, the large beverage container retainer 3 is comprising a pivotally mounted base 31 to which are attached a pair of moveable retaining arms 32 allowing for various diameter beverage containers to be securely held.

Further referring to FIG. 4 there is shown the partial perspective view of FIG. 3 with a beverage container 20 being securely held in the pair of moveable retaining arms 32 of large beverage container retainer 3. Container holder 4 is shown in the folded or closed position as the beverage container 20 is tall enough to be engaged by the large beverage container retainer 3 without the use of said container-retaining platform.

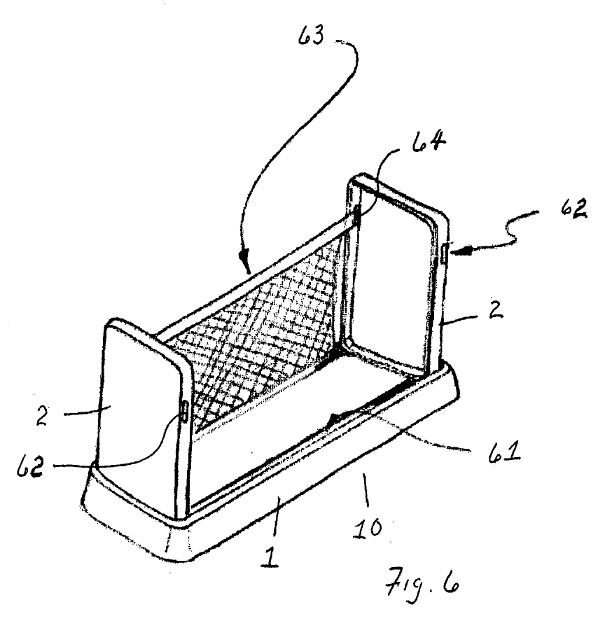

Referring to FIG. 5 there is shown a partial perspective view of the present invention folding floor console 10 in an open or use position and having moveably mounted therein a CD or DVD holder 5 having a CD or DVD storage device 51 located on each interior side of said folding floor console 10 suitable for storing at least one CD or DVD 50. In a preferred embodiment one end of each storage device 51 is pivotally mounted to the interior side of the lid 2 and the other end of each storage device 51 is slidably mounted to the interior side of tray base unit 1.

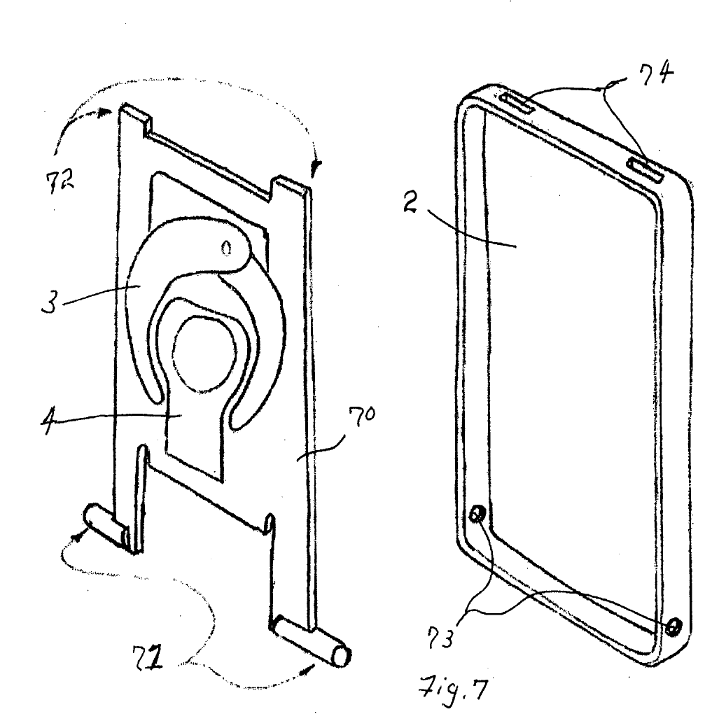

Referring to FIG. 6 a perspective view of another embodiment of the present invention 10 where a pair of lids 2 are in an open position and form a pair of end walls for an open bin storage container enclosed on its sides by flexible walls 63 (one shown in an extended position). The lids 2 each have a pair of slots 62 one on each side near the end not attached to the base unit 1 for receiving the end tabs 64 of flexible walls 63. Base unit 1 has a pair of flexible wall 63 storage slots 61 located on each long side upper edge of said base unit 1. In use the flexible walls 63 are pulled up out of storage slots 61 and end tabs 64 are engaged in complimentary slots 62. When the storage bin is not needed the end tabs 64 are disengaged from complimentary slots 62 and the flexible walls 63 are stored in base unit 1 storage slots 61.

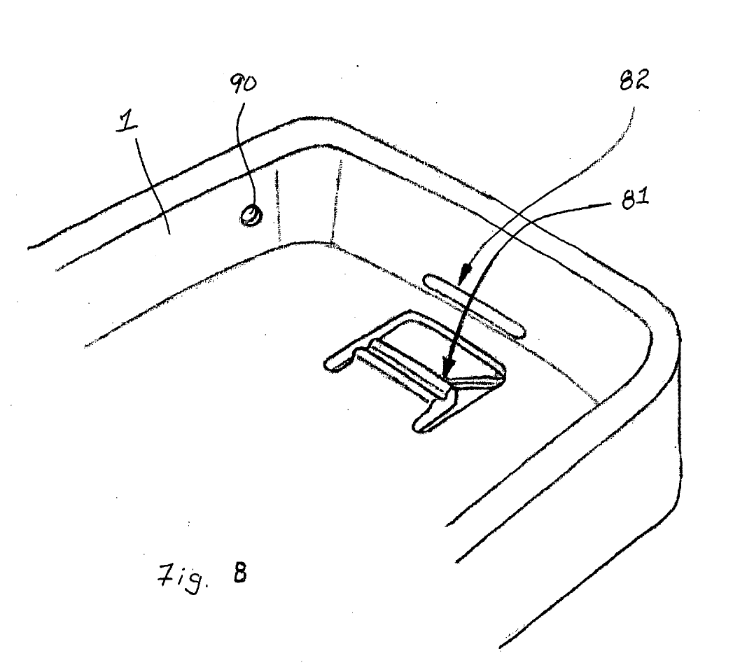

Now referring to FIG. 7 there is shown a perspective exploded view of a lid 2 having a pair of beverage holder locking bores 74 located on one end of lid 2 and a pair of beverage mounting bores 73 located on the sides of lid 2 near the end opposite that having the locking bores 74. Also shown is the beverage holder base 70 that moveably mounts in lid 2 by means of a pair of mounting pins 71 and locks into a use position by way of a pair of locking tabs 72 mountable in complimentary beverage holder locking bores 74. Mounting pins 71 extend through the complimentary lid bores 73 and mount the combined beverage holder base 70 and lid 2 to base unit 1 by mounting pins 71 also engaging base unit 1 complimentary bores 90 (see FIG. 8). In use the beverage holder base 70 is locked into lid 2 by means of locking tabs 72 and locking bores 74. The beverage holder 3 may then be used as desired. When not in use the beverage holder base 70 may be disengaged from locking bores 74 and folded down in the base unit 1 (see FIGS. 1 and 2).

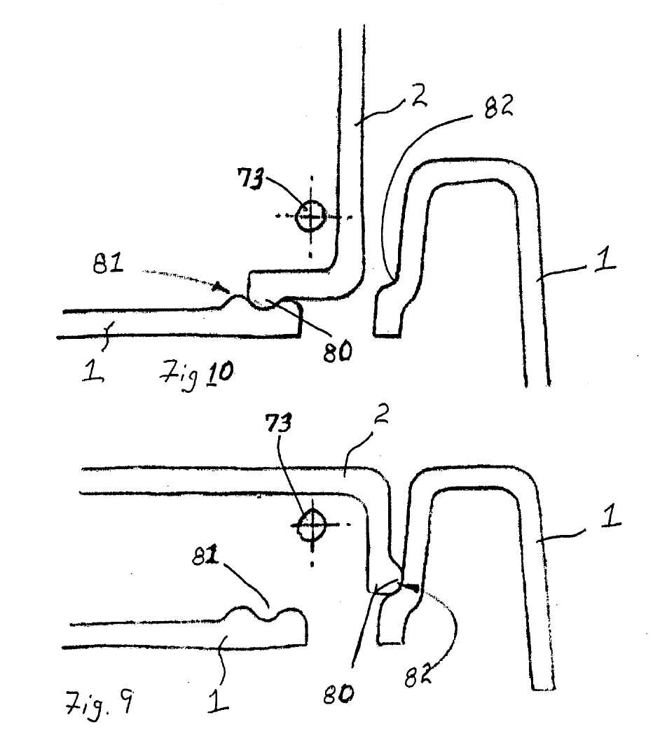

Referring to FIGS. 8 there is shown a perspective view of one end of a base unit 1 having located therein lid mounting bores 90 and a lid position locking detents 81 and 82 for holding the lid 2 either in a closed condition by engagement with detent 82 or in an open condition by engagement with detent 81 (see FIGS. 9 and 10).

Finally referring to FIG. 9 and 10 there are shown partial plan cross-sectional views of the base unit 1 showing detents 81 and 82 and the engagement of lid 2 in both the closed (FIG. 9) and open (FIG. 10) positions. In FIG. 9 is shown the lid 2 having bore 73 and detent engaging section 80 in a closed position with the detent engaging section 80 being engaged with detent 82. In FIG. 10 is shown the lid 2 having bore 73 and detent engaging section 80 in an open position with the detent engaging section 80 being engaged with detent 81.

Suitable pivoting mounting devices are well known in the art and may be used in the present invention. Likewise, suitable movable mounting devices for use with the present invention are well known in the art and may be used in the present invention. No further explanation is required for those skilled in this art. It is also well known by those skilled in the art as to how to mount permanently or removably the present invention to the floor of a vehicle and no further explanation is required here.

It is to be understood that the number of pivotally mounted lids 2 may vary as desired. Thus, there may be a single pivotally mounted lid 2 mounted in tray base unit 1 or there may be two or more said pivotally mounted lids 2 mounted in tray base unit 1.

It is also to be understood that the use of the term “floor” is used to encompass not only that specific area of the interior of a vehicle but in fact any surface capable of having the present invention mounted to it.

It is to be further understood that the folding floor console 10 of the present invention may be mounted directly to the floor of the vehicle passenger compartment or it may be mounted on top of another structures such as an armrest or storage console for example.

The folding floor console 10 may be made from any suitable material well known in the art. Preferred materials are polypropylene, reinforced polypropylene, ABS, polycarbonate, polycarbonate/ABS, nylon, and polyacetal. It is to be further understood that the folding floor console 10 may be made from the same or different materials suitable for the particular application. For example the folding floor console 10 may be made from metals such as, for example, aluminum, steel, and other metals to provide greater strength for applications that may require it. It is also to be understood that the lid 2 may be pivotally mounted to the base 1 using any suitable pivoting device well known in the art. Suitable pivoting devices include, for example, living hinges, piano hinges, pins, and the like.

Although the preferred embodiments of the present invention has been disclosed, various changes and modifications may be made without departing from the scope of the invention as set forth in the appended claims.

What is claimed is:

1. A folding floor console for mounting in a vehicle to hold miscellaneous and personal items in an organized manner comprising:
a tray-like base unit having pivotally mounted therein at least one lid, allowing said at least one lid to move from a closed position to an open position; and
said at least one lid having an exterior surface and an interior surface wherein on said interior surface is mounted a pivoting storage device;
thereby allowing for the storage of miscellaneous and other personal items as desired when said at least one lid is in an open position and providing a unencumbered vehicle compartment space when said at least one lid is in a closed position.

2. The folding floor console as claimed in claim 1 wherein, there are two lids pivotally mounted in the tray base unit.

3. The folding floor console as claimed in claim 1 wherein, there at more than two lids pivotally mounted in the tray base unit.

4. The folding floor console as claimed in claim 2 wherein, each of said two lids contains a mounted pivoting beverage container storage device and a pivotally mounted beverage container-retaining platform.

5. The folding floor console as claimed in claim 2 wherein, one of said two lids contains a pivotally mounted beverage container storage device and a pivotally mounted beverage container-retaining platform and the other of said two lids contains a device for storing CDs and DVDs.

6. The folding floor console as claimed in claim 3 wherein, each of said more than two lids contains a pivotally mounted beverage container storage device and a pivotally mounted beverage container-retaining platform.

7. The folding floor console as claimed in claim 3 wherein, at least one of said two lids contains a pivotally mounted beverage container storage device and a pivotally mounted beverage container-retaining platform and at least one other of said more than two lids contains a device for storing CDs and DVDs.

8. The folding floor console as claimed in claim 1 wherein, said folding floor console comprises an injection molded plastic.

9. The folding floor console as claimed in claim 8 wherein, said injection molded plastic is selected from the group consisting of polypropylene, reinforced polypropylene, ABS, polycarbonate, polycarbonate/ABS, nylon, and polyacetal.

10. A folding floor console for mounting in a vehicle to hold beverage containers and personal items in an organized manner comprising:
a tray base unit having two ends and two sides wherein there is a storage slot located in each of said two sides and having pivotally mounted therein one lid at each of said ends, and further having a flexible extendable sidewall stored in each of said storage slots, and allowing said one lid at each of said ends to move from a closed position to an open position; and
said at least one lid having an exterior surface and an interior surface and a bore on each side located near the end not pivotally mounted to said tray base unit for receiving the end tabs of the flexible extendable sidewalls for locking said sidewalls in a use position; and
a pair of flexible extendable sidewalls having one edge mounted to said tray base unit and the other edge free and having an end tab mounted in each corner, one said flexible extendable sidewall mounted in each of said storage slots of said tray base unit and extendable from a storage position within said storage slots to an open position;
thereby allowing for the storage of personal items as desired when said lids are in an open position and said sidewalls are extended, and providing a unencumbered vehicle compartment space when said sidewalls are in a storage slot and said lids are in a closed position.

11. The folding floor console as claimed in claim 10 wherein, said folding floor console comprises an injection molded plastic.

12. The folding floor console as claimed in claim 11 wherein, said injection molded plastic is selected from the group consisting of polypropylene, reinforced polypropylene, ABS, polycarbonate, polycarbonate/ABS, nylon, and polyacetal.

13. The folding floor console as claimed in claim 10 wherein, said flexible extendable sidewalls are selected from the group consisting of plastic film, plastic mesh, fabric cloth, and fabric mesh.

14. A folding floor console for mounting in a vehicle to hold miscellaneous and personal items in an organized manner comprising:
a tray base unit having pivotally mounted therein at least one lid, allowing said at least one lid to move from a closed position to an open position; and
said at least one lid having an exterior surface and an interior surface wherein on said interior surface is mounted a pivoting storage device;
thereby allowing for the storage of miscellaneous and other personal items as desired when said at least one lid is in an open position and providing a unencumbered vehicle compartment space when said at least one lid is in a closed position.

15. The folding floor console as claimed in claim 14 wherein, there are two lids pivotally mounted in the tray base unit.

16. The folding floor console as claimed in claim 15 wherein, each of said two lids contains a beverage holder base pivotally mounted therein.

18. The folding floor console as claimed in claim 14 wherein, one of said two lids having a beverage holder base pivotally mounted therein and the other of said two lids having a storage device for storing CDs and DVDs pivotally mounted thereon.

19. The folding floor console as claimed in claim 14 wherein, said folding floor console comprises an injection molded plastic.

20. The folding floor console as claimed in claim 19 wherein, said injection molded plastic is selected from the group consisting of polypropylene, reinforced polypropylene, ABS, polycarbonate, polycarbonate/ABS, nylon, and polyacetal.
